(19) United States
(12) Patent Application Publication
(10) Pub. No.: US 2025/0308056 A1
(43) Pub. Date: Oct. 2, 2025

(54) IMAGE PROCESSING APPARATUS, IMAGE PROCESSING METHOD, AND COMPUTER-READABLE STORAGE MEDIUM

(71) Applicant: CANON KABUSHIKI KAISHA, Tokyo (JP)

(72) Inventor: SHO NAKAMURA, Tokyo (JP)

(21) Appl. No.: 19/082,339

(22) Filed: Mar. 18, 2025

(51) Int. Cl. G06T 7/70; G06T 7/00

(52) U.S. Cl. CPC G06T 7/70; G06T 7/0002; G06T 2207/10152

(57) ABSTRACT

An image processing apparatus includes an obtaining unit to obtain a luminance value obtained by reading a transparent substrate, which is a transparent substrate conveyed by a conveyance unit included in a printing apparatus configured to print an image on each page, and, on which a mark indicating a leading position of the page is already printed, a calculation unit to calculate a distance by which the transparent substrate is conveyed by the conveyance unit while the luminance value obtained by the obtaining unit is being kept within a certain range, and a determination unit to determine a position of the mark on the transparent substrate based on the distance calculated by the calculation unit.

### CROSS-REFERENCE TO PRIORITY APPLICATION

This application claims the benefit of Japanese Patent Application No. 2024-057305, filed on Mar. 29, 2024, which is hereby incorporated by reference herein in its entirety.

### BACKGROUND OF THE INVENTION

### Field of the Invention

The present disclosure relates to a technique for detecting a mark indicating a print position.

### Description of the Related Art

Heretofore, various controls on objects have been performed by reading and detecting marks formed on the objects by a scanner. Japanese Patent Laid-Open No. 2010-41673 discloses a technique including reading, with a scanner, a handwritten manuscript on which a mark indicating a handwritten area is formed, and identifying the pixels with a color of the mark based on luminance information and color difference information of the area including the mark, thereby detecting the position of the mark.

There is also a technique including forming a position detection mark on a sheet to be printed, determining the leading position of a page to be printed based on the position detection mark on the sheet being conveyed, and thereby determining an image formation position. In this regard, in a case where a sheet to be printed has visible light transparency, luminance information cannot be stably obtained for an area other than the mark formed on the sheet, which results in a failure to detect the mark with high accuracy.

### SUMMARY OF THE INVENTION

An image processing apparatus in one aspect of the present disclosure includes: an obtaining unit configured to obtain a luminance value obtained by reading a transparent substrate which is a transparent substrate conveyed by a conveyance unit included in a printing apparatus configured to print an image on each page, and on which a mark indicating a leading position of the page is already printed; a calculation unit configured to calculate a distance by which the transparent substrate is conveyed by the conveyance unit while the luminance value obtained by the obtaining unit is being kept within a certain range; and a determination unit configured to determine a position of the mark on the transparent substrate based on the distance calculated by the calculation unit.

Further features of the present invention will become apparent from the following description of exemplary embodiments with reference to the attached drawings.

### BRIEF DESCRIPTION OF THE DRAWINGS

FIG. 1 is a diagram illustrating an example of an apparatus configuration of an image processing apparatus;

FIG. 2 is a diagram illustrating an example of a control configuration of the image processing apparatus;

FIG. 3 is a flowchart for explaining page position determination processing;

FIG. 4 is a diagram illustrating an example of a mark formation position on a page;

FIG. 5 is a flowchart for explaining a mark detection process; and

FIG. 6 is a schematic diagram illustrating an example of a relationship between a sheet conveyance distance and a luminance value of a mark.

### DESCRIPTION OF THE EMBODIMENTS

Hereafter, preferred embodiments of the present disclosure will be described in detail with reference to the attached drawings. The following embodiments are not intended to limit the matters disclosed herein. In addition, the combinations of features described in the following embodiments are not necessarily essential for the solution of the present disclosure. Here, the same constituent elements will be designated with the same reference sign. The present embodiments will be described by taking an image processing apparatus as an example of an information processing apparatus, but the information processing apparatus is not limited to this.

### Embodiments

### Outline

Heretofore, among substrates such as roll paper, there is a substrate for forming a label sticker (hereinafter also referred to as a sheet as needed). A backing sheet is attached to such a sheet in a peelable manner with an adhesive layer interposed in between, and an area with a label formed is peeled off from the backing sheet and is used as a label sticker. In order to form a large number of label stickers, a sheet is divided into multiple pages for use in some cases. In the case where a sheet is divided into multiple pages, a mark is formed on a page on which a print job is to be started among the multiple pages, and the formation of an image based on the print job is started with detection of the mark. Recently, some sheets and backing sheets have visible light transparency. Using such sheets and backing sheets, it is possible to create entertaining labels, such, for example, as labels featuring cartoon characters. However, in the case where the sheet is a transparent substrate having visible light transparency and the backing sheet is a transparent backing sheet having visible light transparency, use of the luminance value to detect the mark has a possibility that the luminance value will be erroneously detected. For example, base plates, various units, and so on are provided to a sheet conveyance path. In a case where a mark on a sheet having visible light transparency is detected by using the luminance value of the mark while the sheet is being conveyed along the above conveyance path, there may be a situation where the luminance value of the mark is unstable due to the installation environment including the base plates, the various units, and so on. For this reason, in the present disclosure, based on a distance by which the transparent substrate is conveyed while the luminance value of a mark, which is printed on a transparent substrate and which indicates the leading position of a page, is being kept within a certain range, the position of the mark on the transparent substrate is determined. According to this operation, the position of the mark is determined if the luminance value of the mark is kept stable while the transparent substrate is being conveyed. This makes it possible to correctly detect a mark formed on a sheet having visible light transparency. In addition, since the position of the mark is correctly detected, a print start position and a print position for an image based on a print job (also referred to as a job as needed) can be controlled appropriately. In addition, based on a relationship between a mark and an image formation area where an image is to be formed, the image formation area can be identified and controlled for each of pages in a sheet. Hereinafter, the present disclosure will be specifically described.

### Apparatus Configuration

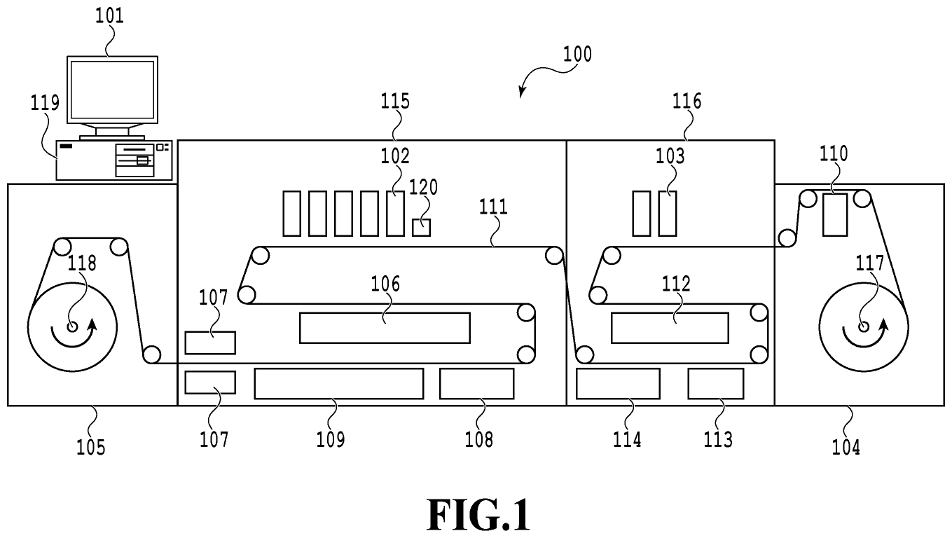

FIG. 1 is a diagram illustrating an example of an apparatus configuration of an image formation system 100. The image formation system 100 is an apparatus to form an image on a sheet. The sheet is specifically continuous paper (hereinafter also referred to as roll paper) 111 on which continuous image formation is possible. A backing sheet may be attached to the roll paper 111 in a peelable manner. The backing sheet is laminated on one surface of the sheet in the peelable manner. In addition, a mark is formed on the other surface of the sheet. The mark is an identifier, printed at the leading position of a page formed on the sheet, for identifying the leading position of the page. The details of the mark will be described later. Thus, if the mark is detected, the leading position of the page is determined. In a case of forming an image in a predetermined image formation area on a page, the position where to form an image is correctly identified. In the example of FIG. 1, the image formation system 100 includes a paper feeding apparatus 104, a first printing apparatus 116, a second printing apparatus 115, a paper delivery apparatus 105, a control personal computer (PC) 119, and a user interface (UI) operation panel 101. An apparatus including some of multiple functions implementing the image formation system 100 is also referred to as an image processing apparatus.

Hereinafter, an apparatus configuration of the image formation system 100 will be specifically described. The paper feeding apparatus 104 is an apparatus to store the roll paper 111 and feed the stored roll paper 111 to a downstream side. The paper feeding apparatus 104 includes a conveyance roller, a paper feeding roller, a skew correction device 110, and so on. The paper feeding apparatus 104 rotates a paper core of the roll paper 111 around a rotation shaft 117 and thereby conveys the roll paper 111 wound around the paper core to the downstream side at a constant conveyance speed via the conveyance roller and the paper feeding roller. In the example of FIG. 1, the first printing apparatus 116 (also referred to as the printing apparatus) is disposed downstream of the paper feeding apparatus 104. The skew correction device 110 corrects a misalignment of the roll paper 111 as appropriate due to conveyance of the roll paper 111. The first printing apparatus 116 is a unit configured to perform printing with a spot color. The first printing apparatus 116 specifically includes a first print head 103, a drying device 112, a cooling device 113, and a cooling device 114. The first print head 103 is a device configured to print images with a spot color (for example, a white ink or the like) other than the print basic colors (CMYK). An image formation method of the first print head 103 is, for example, an inkjet method, but is not particularly limited and may be an electrophotographic method. For example, the first print head 103 prints a mark on the roll paper 111 with the white ink. The drying device 112 dries the roll paper 111 on which the image is printed with the spot color. The cooling device 113 and the cooling device 114 cool the roll paper 111 which is hot due to drying by the drying device 112. The cooled roll paper 111 is fed to the downstream side of the first printing apparatus 116. The second printing apparatus 115 (also referred to as the downstream printing apparatus) is disposed downstream of the first printing apparatus 116. The second printing apparatus 115 is a unit configured to perform printing with the print basic colors.

The second printing apparatus 115 includes a mark detection sensor 120, a second print head 102, a drying device 106, a scanner device 107, a cooling device 108, and a cooling device 109. The mark detection sensor 120 is a sensor configured to detect the mark printed on the roll paper 111. The mark detection sensor 120 is the sensor configured to detect the mark printed on the roll paper 111 by detecting a luminance value of the mark. The mark detection sensor 120 includes, for example, a light emission unit and a light reception unit. The light emission unit emits light to the roll paper 111. The light reception unit receives the light reflected from the roll paper 111 or other objects, and detects the luminance value based on the received light. The second print head 102 is a device configured to print predetermined images with the print basic colors. An image formation method of the second print head 102 is, for example, an inkjet method, but is not particularly limited and may be an electrophotographic method. The second print head 102 determines the leading position of a page laid out on the roll paper 111 based on the mark detected by the mark detection sensor 120. The second print head 102 prints an image on the roll paper 111 based on the determined leading position. The drying device 106 dries the roll paper 111 on which the image is printed with the print basic colors. The cooling device 108 and the cooling device 109 cool the roll paper 111 which is hot due to drying by the drying device 106. The scanner device 107 feeds the roll paper cooled by the cooling device 108 and the cooling device 109 to a downstream side. The paper delivery apparatus 105 is disposed downstream of the second printing apparatus 115. The paper delivery apparatus 105 is an apparatus configured to wind up the roll paper 111 conveyed from the second printing apparatus 115. The paper delivery apparatus 105 includes a conveyance roller, a paper feeding roller, and the like. The paper delivery apparatus 105 holds the roll paper 111 wound around a paper core of a rotation shaft 118 in a roll form. The roll paper 111 is conveyed through the conveyance roller and the paper feeding roller and is wound up on the paper core of the rotation shaft 118 at a constant conveyance speed.

The roll paper 111 can be set in the following way. Specifically, before the start of printing, the roll paper 111 is first set in the paper feeding apparatus 104. After the roll paper 111 is set in the paper feeding apparatus 104, the leading edge of the roll paper 111 is set to pass above the skew correction device 110. Then, in the first printing apparatus 116, the roll paper 111 is set to pass below the first print head 103, below the drying device 112, above the cooling device 113, and above the cooling device 114. In the second printing apparatus 115, the roll paper 111 is set to pass below the mark detection sensor 120, below the second print head 102, below the drying device 106, above the cooling device 108, and above the cooling device 109, and then is set to pass through the scanner device 107. Subsequently, the roll paper 111 set through the scanner device 107 is wound up by the paper delivery apparatus 105. The control PC 119 is placed on the paper delivery apparatus 105. The UI operation panel 101 is placed on the control PC 119. A user inputs a print job to the control PC 119. After inputting the print job, the user operates a print start button (not illustrated) displayed on the UI operation panel 101, so that the printing is started. The printed image is read by the scanner device 107. The control PC 119 analyzes the read image to inspect whether or not the image has a defect as a printed product.

### Control Configuration

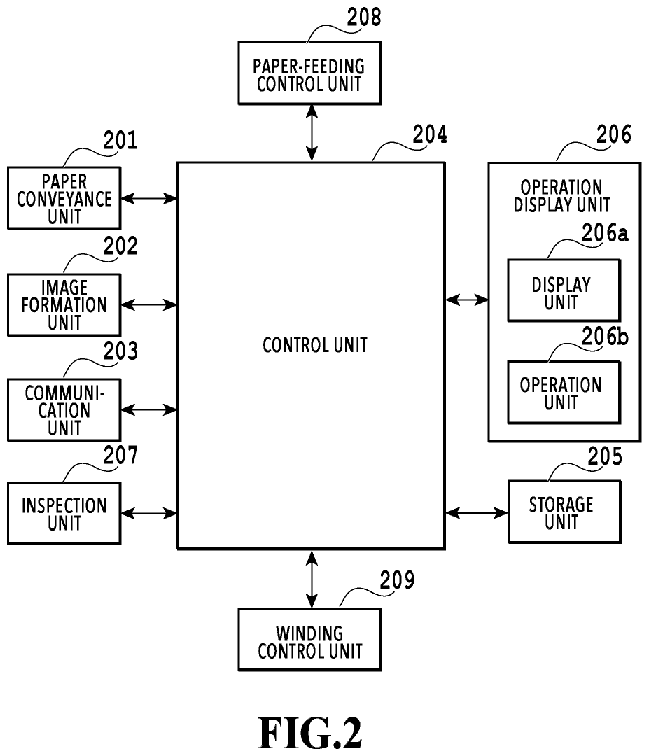

Next, a control configuration of the image formation system 100 will be described in detail. FIG. 2 is a diagram illustrating an example of a control configuration of the image formation system 100. As illustrated in FIG. 2, the image formation system 100 includes a paper conveyance unit 201, an image formation unit 202, a communication unit 203, a control unit 204, a storage unit 205, an operation display unit 206, an inspection unit 207, a paper-feeding control unit 208, and a winding control unit 209. The control unit 204 is a mechanism to control the paper conveyance unit 201, the image formation unit 202, the communication unit 203, the operation display unit 206, the inspection unit 207, the paper-feeding control unit 208, and the winding control unit 209. The control unit 204 includes, for example, a central processing unit (CPU), a random access memory (RAM), and so on. The CPU in the control unit 204 reads various programs stored in the storage unit 205 such as a system program and a processing program, expands the programs on the RAM, and executes various kinds of processing according to the expanded programs. For example, the control unit 204 is capable of performing image formation processing to execute a print job in response to a user's instruction. The user's instruction is received, for example, from the control PC 119. The storage unit 205 includes, for example, a non-volatile semiconductor memory (a so-called flash memory), a hard disk drive (HDD), a combination thereof, or the like. The storage unit 205 stores the various programs such as the system program and the processing program to be executed by the control unit 204 and various types of data necessary for executing these programs. The paper conveyance unit 201 includes multiple rollers. The paper conveyance unit 201 is a mechanism to convey the roll paper 111 inside the image formation system 100. For example, a situation is assumed in which the roll paper 111 is conveyed from the paper-feeding control unit 208 to the image formation unit 202. In this situation, the paper conveyance unit 201 conveys the roll paper 111 conveyed from the paper-feeding control unit 208 to the image formation unit 202. For example, another situation is also assumed in which the roll paper 111 is conveyed from the image formation unit 202 to the winding control unit 209. In this situation, the paper conveyance unit 201 conveys the roll paper 111 after passing through the image formation unit 202 to the winding control unit 209. Next, mechanisms of the paper-feeding control unit 208, the image formation unit 202, and the winding control unit 209 will be described. The paper-feeding control unit 208 is a mechanism to convey the roll paper 111 in the paper feeding apparatus 104 and feed the roll paper 111 to the image formation unit 202. For example, according to a control instruction from the control unit 204, the paper-feeding control unit 208 feeds the roll paper 111 to the image formation unit 202. The image formation unit 202 is a mechanism to cause both of the second printing apparatus 115 and the first printing apparatus 116 to form images on the roll paper 111 fed from the paper-feeding control unit 208 based on print data for which an output instruction is received. After forming the images on the roll paper 111, the image formation system 100 conveys the roll paper 111 on which the images are formed to the winding control unit 209. The winding control unit 209 is a mechanism to wind up the roll paper 111 in the paper delivery apparatus 105.

The communication unit 203 is a mechanism to transmit and receive various kinds of data to and from an external apparatus (for example, a personal computer) connected to a communication network such as a local area network (LAN) or a wide area network (WAN). The communication unit 203 includes, for example, a communication control card such as a LAN card. The operation display unit 206 is a mechanism to receive inputs by the user and display information on the received inputs by the user. The operation display unit 206 includes a display unit 206a and an operation unit 206b. The display unit 206a is a mechanism to display various kinds of information on a display screen according to a display control signal input from the control unit 204. The display unit 206a may include, for example, a liquid crystal display (LCD). The operation unit 206b is a mechanism to receive various input operations by the user, and output operation signals to the control unit 204. The operation unit 206b includes various operation keys such as ten keys and a start key. The operation unit 206b may include, for example, a touch panel. The operation display unit 206 may include a liquid crystal display with a touch panel in which the touch panel is laminated on the liquid crystal display. The operation display unit 206 may be used in execution of a job, for example, for setting various kinds of information related to the job or doing the like. The various kinds of information related to a job include, for example, a type of paper to be used, a print speed, the number of pages to be printed, the number of copies to be printed, a print length, a print weight, and a print diameter. The user is allowed to set at least one condition among these various kinds of information related to a job as needed via the operation display unit 206.

The inspection unit 207 is a mechanism to check whether or not the image is printed on the roll paper 111 without any ejection defect. In a case where the image formation unit 202 prints an inspection pattern for an ejection defect inspection, the inspection unit 207 reads the image printed on the roll paper 111 by using the scanner device 107 and determines whether or not the printed image has an ejection detect. If determining that the image has an ejection defect, the inspection unit 207 stops the image formation system 100. In the above example, the inspection in which the image of the inspection pattern printed by the image formation unit 202 is read by the scanner device 107 is described, but the inspection is not limited to this. For example, an inspection may be made in which a camera not illustrated or the scanner device 107 directly reads the image printed on the roll paper 111. Instead, an inspection may be made in which states of ink ejection from nozzles are monitored.

### Outline of Print Operation

Next, a print operation on the roll paper 111 by the image formation system 100 will be described. First, using an external apparatus, the user creates data of a print job, and makes print settings for the print job and a delivery roll number setting of the roll paper 111. Next, the user transmits the print setting information for the print job and the delivery roll number setting information of the roll paper 111 to the image formation system 100 via the communication network. The control unit 204 receives the data of the job and a job ticket (also referred to as print settings) transmitted from the external apparatus via the communication unit 203, the job ticket containing the printing setting information for the print job, the delivery roll number information of the roll paper 111, and so on. After that, the image formation system 100 performs printing according to the job ticket. Only in the case where the image formation system 100 correctly detects the positions of pages to be formed on the roll paper 111, the image formation system 100 can perform printing without misregistration of the image positions. A mark detection operation is one of operations for detecting the position of the page. Next, the mark detection operation will be described.

### Page Position Determination Processing

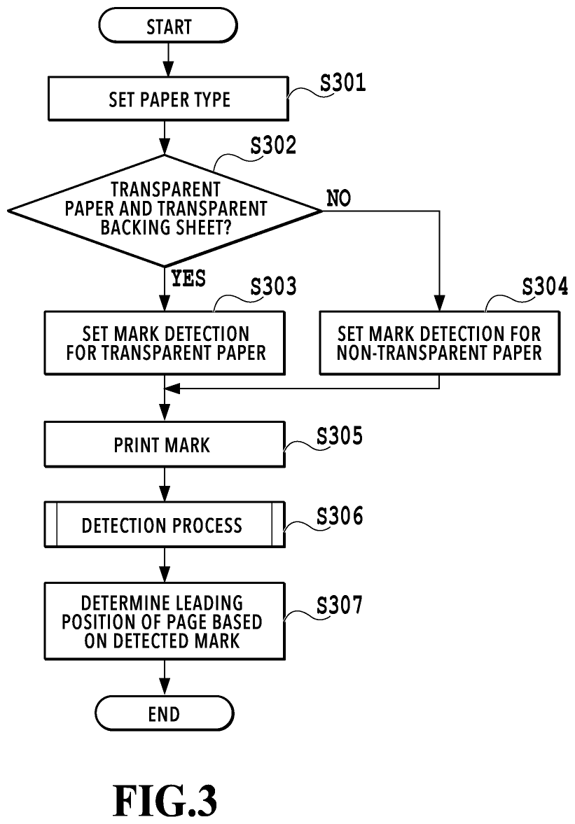

FIG. 3 is a flowchart for explaining page position determination processing. The processing presented in FIG. 3 is implemented by the control unit 204 executing a program stored in the storage unit 205. The processing presented in FIG. 3 may be executed, for example, at timing at which the page position determination processing is invoked. In other words, the processing presented in FIG. 3 is implemented by the CPU in the control unit 204. Some or all of functions in steps of FIG. 3 may be implemented by hardware such as an ASIC or electronic circuit. Sign “S” in description of each process indicates a step in this flowchart. The processing in FIG. 3 mainly include the following processes: a sheet type setting process (S301), a mark detection setting process according to the sheet type (S302 to S304), a mark printing process (S305), a mark detection process (S306), and a page position determination process based on the mark (S307). The processing presented in FIG. 3 includes different processes depending on whether or not a sheet and a backing sheet are transparent. In the following description, a transparent sheet, that is, a sheet having visible light transparency, will be referred to as transparent paper (also referred to as a transparent substrate) as needed and a sheet will be referred to as paper as needed. A transparent backing sheet, that is, a backing sheet having visible light transparency, will be referred to as transparent backing paper as needed in the following description. To have visible light transparency means to have a function to transmit visible light. Thus, the transparent paper and the transparent backing paper do not have to have a visible light transmittance of 100%. The processing presented in FIG. 3 is processing including detecting a luminance value of each of multiple detection target marks on the transparent paper and the transparent backing paper, and determining the presence of a mark if the detected luminance value falls within a certain range. Then, the leading position of the page is identified from the determined mark, so that the image formation position can be controlled. In the present embodiment, the mark detection sensor 120 detects the detection target mark to identify the leading position of the page, and the second print head 102 forms an image in alignment with an image formed by the first print head 103. In the present embodiment, since the roll paper is used for printing, the processing described below is based on the assumption of a use case where the paper is set in advance at the position of the mark detection sensor 120. However, the processing is not limited to such use case of the roll paper. In a case of cut sheets, the cut sheet may be set in any of various ways such as conveying only a single sheet, determining a detection target mark with manual insertion, or user's setting. Thus, a medium for determining a detection target mark to be used is not limited to the roll paper in the present embodiment. The processing presented in FIG. 3 may be executed outside the first printing apparatus 116 and the second printing apparatus 115. For example, the processing presented in FIG. 3 may be executed by the control PC 119. Hereinafter, the processes in S301 to S307 will be specifically described.

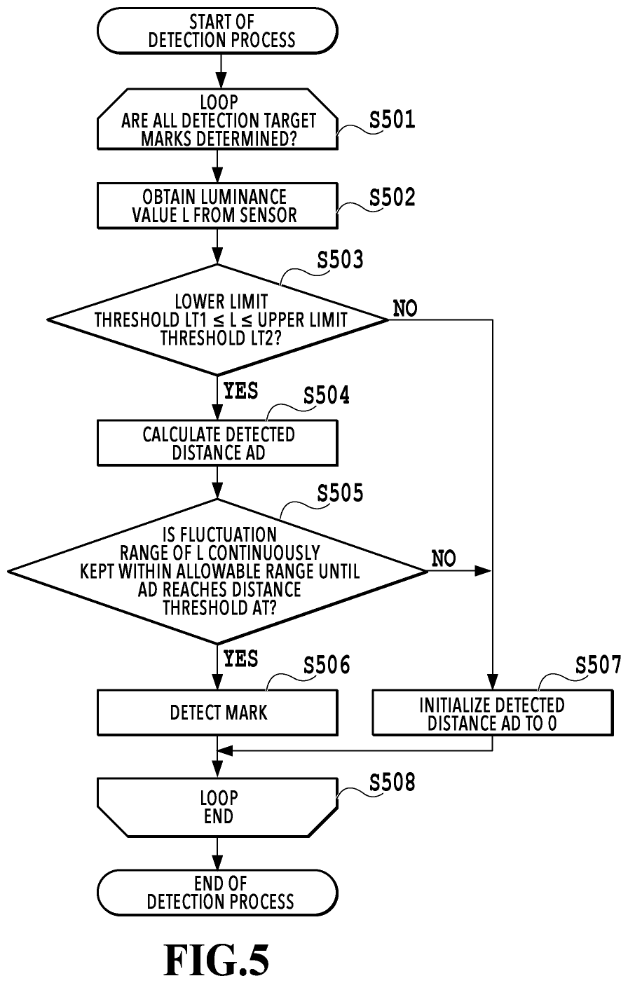

In S301, the CPU in the control unit 204 (hereinafter simply referred to as the CPU as needed) determines a type of paper on which the mark is to be printed. The present embodiment employs an example of a configuration in which the type of paper is set by the user via the operation unit 206b. The mark detection, which will be described in detail later, is not limited to a determination based on the luminance value of the mark. For example, a situation may be employed in which an ultrasonic sensor is installed on an upstream side of the conveyance path in the second printing apparatus 115. In such a situation, a type of paper may be set automatically. In S302, the CPU determines whether the set type of paper is transparent paper and transparent backing paper. The CPU proceeds to the process in S303 from the process in S302 if the set type of paper is transparent paper and transparent backing paper, or, if not, proceeds to the process in S304. In S303, the CPU sets mark detection for the transparent paper. In S304, the CPU sets mark detection for non-transparent paper. In S305, the CPU causes the detection target mark to be printed at a mark print position which will be described later. In S306, the CPU detects the mark by causing the image formation unit 202 to obtain the luminance value by using the mark detection sensor 120. The process related to the luminance value will be described in detail by using FIG. 5. Finally, in S307, the CPU determines the leading position of the page by using the detected mark.

### Mark Formation Position

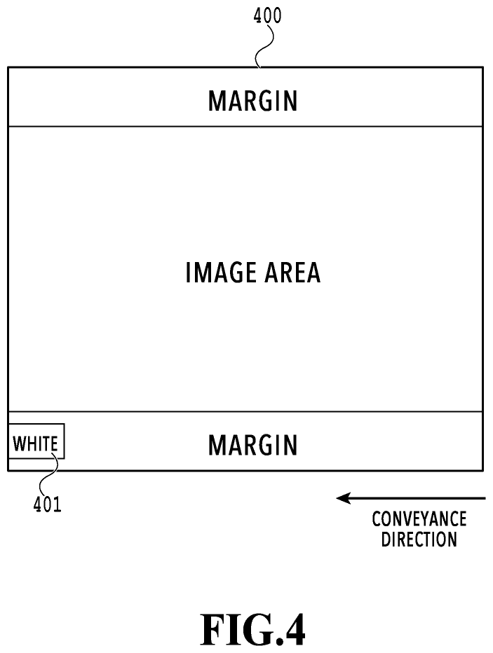

FIG. 4 is diagram illustrating an example of a mark formation position on a page. FIG. 4 illustrates an example in which a detection target mark for identifying the leading position of a page is formed during printing on the roll paper 111. Here, another mark for recognizing an image formation area may be formed additionally. The mark formation is not limited to the use case for identifying the leading position of the page as in the present embodiment. FIG. 4 illustrates an example of a print position in a case where a detection target mark is printed at a fixed print position. An area allocation layout 400 is a one-page layout for printing on the roll paper 111. An image formation area (also referred to as an image area as needed) is allocated between left and right margins of the area allocation layout 400 along the conveyance direction. In this image area, an image based on a print job is formed. In addition, a white detection target mark 401 is printed on one of the left and right margins of the area allocation layout 400 along the conveyance direction. Here, the color of the detection target mark is not limited to the white in the present embodiment. The color of a detection target mark to be printed or the number of detection target marks to be printed may be changed depending on physical properties of paper or the like. Since the position of the mark with respect to the leading position of the image area is determined as a fixed position, the leading position of the page can be identified by using a conveyance distance of the detection target mark used.

### Mark Detection Operation

FIG. 5 is a flowchart for explaining the mark detection process. The process presented in FIG. 5 is implemented by the control unit 204 executing a program stored in the storage unit 205. The process presented in FIG. 5 is executed, for example, at timing at which the mark detection process in S306 of FIG. 3 is invoked. More specifically, the process presented in FIG. 5 is implemented by the CPU in the control unit 204. Some or all of functions in steps of FIG. 5 may be implemented by hardware such as an ASIC or electronic circuit. Sign “S” in description of each process indicates a step in this flowchart. The process presented in FIG. 5 is executed on all the detection target marks formed on the roll paper 111 (S501 to S508). In the execution, first, it is determined whether or not a luminance value L detected by the mark detection sensor 120 falls within a range from a lower limit threshold LT1 to an upper limit threshold LT2 (S503). Next, if the luminance value L detected by the mark detection sensor 120 falls within the range from the lower limit threshold LT1 to the upper limit threshold LT2, the conveyance distance of the roll paper 111 and the luminance value L are continuously detected (S504 and S505). During the continuous detection, if the conveyance distance reaches a distance threshold AT while the luminance value L is kept stable, the mark is detected (S506). If not, whether or not the luminance value L falls within the range from the threshold LT1 to the threshold LT2 is again determined (S501 to S508). Here, the threshold LT1 and the threshold LT2 may be obtained by carrying out various trials on various types of roll paper 111. The distance threshold AT is a value set based on the size of the mark and may be set, for example, to the value of the minimum size of the mark. In the case where the distance threshold AT is set to the value of the minimum size of the mark, the minimum size of the mark can be detected using the distance threshold AT. In sum, the process presented in FIG. 5 is a process in the case of transparent paper in which the control unit 204 uses the mark detection sensor 120 to obtain the luminance value read by the mark detection sensor 120 and detects the mark. However, the process presented in FIG. 5 may be executed outside the first printing apparatus 116 and the second printing apparatus 115. For example, the process presented in FIG. 5 may be executed by the control PC 119. Hereinafter, the processes in S501 to S508 will be specifically described.

In S501, the CPU in the control unit 204 (hereinafter simply referred to as the CPU as needed) determines whether or not all the detection target marks are already determined. If all the detection target marks are already determined, the CPU terminates the processes in S501 to S508 and proceeds to the process in S1307 in FIG. 3. If all the detection target marks are not yet determined, the CPU iterates the processes in S501 to S508. In S502, the CPU obtains the luminance value L from the mark detection sensor 120. In S503, the CPU determines whether the luminance value L is equal to or higher than the lower limit threshold LT1 and equal to or lower than the upper limit threshold LT2. In the present embodiment, a range of values that can be measured by mark detection sensor 120 is set to 0 to 255, and the lower limit threshold LT1=50 and the upper limit threshold LT2=100 are set. These thresholds are not limited to the above example, and may be set according to the precision of the mark detection sensor 120. If LT1≤L≤LT2 holds, the CPU proceeds to the process in S504 from the process in S503. On the other hand, if LT1SL<LT2 does not hold, the CPU proceeds to the process in S507 from the process in S503. In S504, the CPU calculates a detected distance AD under the condition where LT1≤LLT2 holds. Here, the detected distance AD is a conveyance distance by which the roll paper 111 is conveyed during a period in which the luminance value Lis satisfying LT1≤L<LT2. The detected distance AD may be calculated based on a detection result by the mark detection sensor 120. Instead, the detected distance AD may be calculated, for example, according to a rotation speed of a driving roller among the multiple rollers included in the paper conveyance unit 201. Alternatively, multiple passage detection sensors (not illustrated) may be provided along the conveyance path of the roll paper, and the detected distance AD may be calculated according to detection results of these passage detection sensors. In S505, the CPU determines whether or not the detected distance AD is equal to or more than the distance threshold AT. In other words, the CPU determines whether or not the roll paper 111 is conveyed by the distance equivalent to the size of the mark. Specifically, the CPU determines whether or not a fluctuation range of the luminance value Lis continuously kept within an allowable range until the detected distance AD reaches the distance threshold AT. If the mark is the same, the luminance value of the mark must be stable at a constant value. Accordingly, if the constant value is detected as the luminance value L during the detection of the detected distance AD, it means that the same mark is continuously detected. The allowable range herein may be set to a range within which a fluctuation of the luminance value L can be determined as an error range. For example, only if dirt or dust is attached to a part of the mark, the luminance value read by the mark detection sensor 120 fluctuates. In this case, if the fluctuation range is kept within the allowable range, the luminance value L can be regarded as the constant value. In the present embodiment, the distance threshold AT is set to 2 mm. If AD≥AT holds, the CPU detects the mark in S506. In other words, the mark position is determined. If AD<AT holds, the CPU initializes the detected distance AD to 0 in S507, and proceeds to the processes for detecting the next mark. The distance threshold AT is set to 2 mm in the present embodiment, but may be changed depending on the size of the mark to be actually printed.

### Relationship Between Sheet Conveyance Distance and Luminance Value of Mark

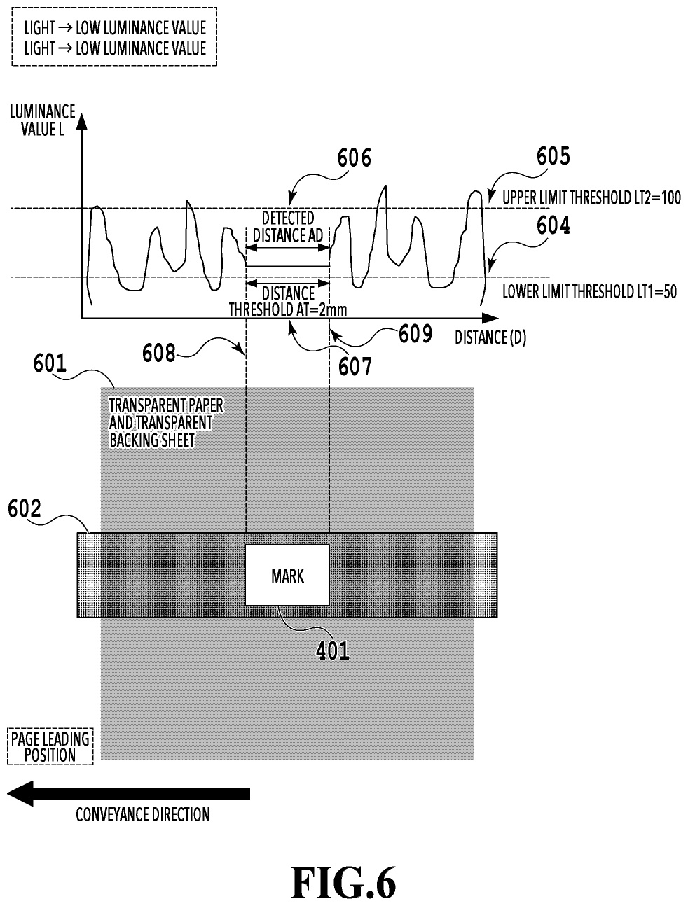

FIG. 6 is a schematic diagram illustrating an example of a relationship between a sheet conveyance distance and a luminance value of a mark. A label sticker 601 is composed of transparent paper and transparent backing paper. An apparatus component 602 schematically represents an object which is located below the paper (below in the vertical direction) and which can be seen through the paper. The apparatus component 602 is, for example, an internal unit in the image formation system 100 or printed paper to be conveyed. Thus, since the label sticker 601 is transparent, light emitted from the light emission unit in the mark detection sensor 120 reaches the apparatus component 602 located below the label sticker 601. For this reason, the luminance value obtained from the light incident on the light reception unit of the mark detection sensor 120 is not constant. In other words, even though the luminance value can be obtained from the mark detection sensor 120, the obtained luminance value is not stable as presented in a graph on an upper side of FIG. 6. Upon arrival of a state where the luminance value L detected by the mark detection sensor 120 falls within a range from a threshold LT1 604 to a threshold LT2 605, the calculation of a detected distance AD 606 is started. As presented in FIG. 6, a distance threshold AT 607 between auxiliary lines 608 and 609 is set to the size of the mark along the sheet conveyance direction. Thus, it is possible to determine the position of the mark if the fluctuation range of the luminance value Lis continuously kept within the allowable range until the detected distance AD 606 reaches the distance threshold AT 607 as presented in FIG. 6. To put it differently, based on the distance by which the transparent substrate is conveyed while the luminance value of the mark, which is printed on the transparent substrate and which indicates the leading position of the page, is being kept within the certain range, the position of the mark on the transparent substrate is determined. In this connection, the darker the color of the mark, the lower the luminance value L. On the other hand, the lighter the color of the mark, the higher the luminance value L. Accordingly, the threshold LT1 and the threshold LT2 may be determined as appropriate depending on the color of the mark.

According to the above description, an image processing apparatus includes an obtaining unit, a calculation unit, and a determination unit. The obtaining unit obtains a luminance value obtained by reading a transparent substrate, which is being conveyed by a conveyance unit included in a printing apparatus configured to print an image on each page, and on which a mark indicating the leading position of the page is already printed. The calculation unit calculates a distance by which the transparent substrate is conveyed by the conveyance unit while the luminance value obtained by the obtaining unit is being kept within the certain range. The determination unit determines a position of the mark on the transparent substrate based on the distance calculated by the calculation unit. According to this operation, the position of the mark is determined if the luminance value of the mark is kept stable while the transparent substrate is being conveyed. This makes it possible to correctly detect a mark formed on a sheet having visible light transparency.

The determination unit may determine that the luminance value obtained by the obtaining unit falls within the certain range if the luminance value is continuously kept within the allowable range. According to this operation, even if the luminance value fluctuates slightly due to dust or dirt adhering to part of the mark in the detection of the luminance value, it is possible to treat such fluctuation by determining that the luminance value is within the error range.

Transparent backing paper is attached to the transparent substrate in a peelable manner. The image processing apparatus may further include an image formation unit equipped with a white ink and configured to form an image on the transparent substrate with the white ink. This configuration forms the mark of the white color, which can provide the highest luminance value, and accordingly facilitates detection of a luminance value difference of the mark from the transparent substrate and the transparent backing paper.

The transparent backing paper is attached to the transparent substrate in the peelable manner. The image processing apparatus may further include an image formation unit equipped with an ink of at least one color among cyan, magenta, and yellow and configured to form an image on a transparent substrate with the ink of the at least one color among the cyan, the magenta, and the yellow. With this configuration, it is possible to increase color variations of the mark, making it possible to form a mark in a color suited to a mark detection environment.

The conveyance unit may convey roll paper as the transparent substrate. This operation makes it possible to detect the mark disclosed herein on long paper such as roll paper.

The calculation unit performs the following operation in a case where the luminance value obtained by the obtaining unit falls within a range from a preset first threshold (also referred to as the upper limit threshold LT2) to a preset second threshold (also referred to as the lower limit threshold LT1) which is lower than the first threshold. Specifically, the calculation unit may start to calculate the distance by which the transparent substrate is conveyed. This configuration makes it possible to detect the mark while narrowing down the luminance value.

The image formation unit may form a mark at the leading position of the page. This operation makes it possible to detect the leading position of the page by detecting the mark.

In addition, the image processing apparatus may further include a detection unit (for example, the mark detection sensor 120) installed at a position suited to the position of the mark formed on the transparent substrate and configured to obtain the luminance value by reading the transparent substrate. In this configuration, the distance between the mark and the detection unit can be set appropriately.

Moreover, while the luminance value is continuously kept within the allowable range, the calculation unit may increase the distance as the conveyance of the transparent substrate is advanced. According to this operation, it is possible to correlate the distance with the stable state of the luminance value of the mark, so that the mark can be detected correctly.

The determination unit may determine the position of the mark in a case where the calculated distance reaches a distance threshold AT set based on the size of the mark. This operation makes it possible to correlate the size of the mark and the distance threshold AT with each other, thereby correctly detecting the mark.

The image processing apparatus may further include a downstream image formation unit located downstream of the image formation unit and equipped with an ink different from the white ink. The downstream image formation unit may include, as the different ink, an ink of at least one color among cyan, magenta, and yellow. The downstream image formation unit may form an image based on a print job with the at least one color among the cyan, the magenta, and the yellow in an area different from an area where the mark is present. This operation makes it possible to increase color variations of the mark.

The downstream image formation unit may identify the area different from the mark as an image formation area where the image based on the print job is to be printed, based on the position of the mark determined by the determination unit. This operation makes it possible to identify the image formation area at the correct position.

The downstream image formation unit may start to form the image based on the print job in the image formation area in a case where the downstream image formation unit identifies the different area as the image formation area. This operation makes it possible to form the image at the correct position.

### Modification 1

The example in which the first print head 103 in the first printing apparatus 116 prints an image with a spot color such as a white ink is described above, but the first print head 103 is not particularly limited to this. The first print head 103 may print images with the print basic colors. For example, the first print head 103 may include an ink of at least one color among cyan, magenta, and yellow instead of the white ink. In this case, if both of a sheet and a backing sheet have visible light transparency, the first print head 103 may form a mark with the ink of the at least one color among cyan, magenta, and yellow. With this operation, the mark can be formed with a chromatic color.

### Modification 2

The example of the processes of determining whether or not the luminance value is equal to or higher than LT1 and equal to or lower than LT2, calculating the detected distance AD, and determining whether or not the luminance value is kept at the constant value is described above, but the execution order of the processes is not limited to this. For example, after whether or not the luminance value L is kept at the constant value is determined, the calculation of the detected distance AD and the determination on whether or not the luminance value L is equal to or higher than LT1 and equal to or lower than LT2 may be performed.

### Other Embodiments

Although the various examples and embodiments of the present disclosure are presented and described above, the spirit and scope of the present disclosure should not be limited to the specific description given herein. The present disclosure is not limited to the above embodiments, and various modifications may be made. The present disclosure may be carried out by combining some features in the above embodiments.

In the embodiments, the example in which the distance threshold AT is used to detect the mark, but the processing is not limited to these. For example, in other possible processing, if the conveyance speed of the roll paper 111 is constant, whether or not the roll paper is conveyed by a distance sufficient to detect the entire mark is determined based on the conveyance time of the roll paper 111.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

What is claimed is:

1. An image processing apparatus comprising:
an obtaining unit configured to obtain a luminance value obtained by reading a transparent substrate which is conveyed by a conveyance unit included in a printing apparatus configured to print an image on each page, and on which a mark indicating a leading position of the page is already printed;
a calculation unit configured to calculate a distance by which the transparent substrate is conveyed by the conveyance unit while the luminance value obtained by the obtaining unit is being kept within a certain range; and
a determination unit configured to determine a position of the mark on the transparent substrate based on the distance calculated by the calculation unit.

2. The image processing apparatus according to claim 1, wherein the determination unit determines that the luminance value obtained by the obtaining unit falls within the certain range in a case where the luminance value is continuously kept within an allowable range of a fluctuation range of the luminance value.

3. The image processing apparatus according to claim 1, wherein a transparent backing sheet is attached to the transparent substrate in a peelable manner, and
the image processing apparatus further comprises an image formation unit equipped with a white ink and configured to form the mark on the transparent substrate with the white ink.

4. The image processing apparatus according to claim 2, wherein a transparent backing sheet is attached to the transparent substrate in a peelable manner, and
the image processing apparatus further comprises an image formation unit equipped with an ink of at least one color among cyan, magenta, and yellow and configured to form the mark on the transparent substrate with the ink of the at least one color.

5. The image processing apparatus according to claim 2, wherein the conveyance unit conveys roll paper as the transparent substrate.

6. The image processing apparatus according to claim 2, wherein the calculation unit starts to calculate the distance in a case where the luminance value obtained by the obtaining unit falls within a range from a preset first threshold to a preset second threshold which is lower than the first threshold.

7. The image processing apparatus according to claim 3, wherein the image formation unit forms the mark at the leading position.

8. The image processing apparatus according to claim 2, further comprising a detection unit installed at a position suited to a position of the mark formed on the transparent substrate, and configured to obtain the luminance value by reading the transparent substrate.

9. The image processing apparatus according to claim 6, wherein, in a case when the luminance value obtained by the obtaining unit is continuously kept within the allowable range, the calculation unit increases the distance as conveyance of the transparent substrate is advanced.

10. The image processing apparatus according to claim 2, wherein the determination unit determines the position of the mark in a case where the distance reaches a threshold set based on a size of the mark.

11. The image processing apparatus according to claim 3, further comprising a downstream image formation unit disposed downstream of the image formation unit and equipped with an ink different from the white ink,
wherein the downstream image formation unit includes, as the different ink, an ink of at least one color among cyan, magenta, and yellow, and
the downstream image formation unit forms an image based on a print job with the ink of the at least one color among the cyan, the magenta, and the yellow on an area different from an area where the mark is present.

12. The image processing apparatus according to claim 11, wherein the downstream image formation unit identifies the different area as an image formation area where the image based on the print job is to be printed, based on the position of the mark determined by the determination unit.

13. The image processing apparatus according to claim 12, wherein, in a case when the downstream image formation unit identifies the different area as the image formation area, the downstream image formation unit starts to form the image based on the print job on the image formation area.

14. An image processing method comprising:
obtaining a luminance value obtained by reading a transparent substrate which is conveyed by a conveyance unit included in a printing apparatus configured to print an image on each page, and on which a mark indicating a leading position of the page is already printed;
calculating a distance by which the transparent substrate is conveyed by the conveyance unit while the luminance value obtained in the obtaining is being kept within a certain range; and
determining a position of the mark on the transparent substrate based on the distance calculated in the calculating.

15. A non-transitory computer-readable storage medium that stores a program causing a computer to execute:
obtaining a luminance value obtained by reading a transparent substrate which is conveyed by a conveyance unit included in a printing apparatus configured to print an image on each page, and on which a mark indicating a leading position of the page is already printed;
calculating a distance by which the transparent substrate is conveyed by the conveyance unit while the luminance value obtained in the obtaining is being kept within a certain range; and
determining a position of the mark on the transparent substrate based on the distance calculated in the calculating.
